(19) United States
(12) Patent Application Publication
(10) Pub. No.: US 2026/0146796 A1
(43) Pub. Date: May 28, 2026

(54) MULTI-LAYERED STRUCTURES FOR ELECTRICALLY HEATED FURNACES UTILIZING CONDUCTIVE REFRACTORY MATERIALS

(71) Applicant: SABIC Global Technologies B.V., Bergen op Zoom (NL)

(72) Inventor: Michael Edward Huckman, Bengaluru (IN)

(21) Appl. No.: 19/121,712

(22) PCT Filed: Nov. 9, 2023
(86) PCT No.: PCT/EP2023/081297

§ 371 Date: Apr. 16, 2025

Related U.S. Application Data
(60) Provisional application No. 63/384,233, filed on Nov. 18, 2022.

(30) Foreign Application Priority Data
Feb. 21, 2023 (EP) 23157692.7

(51) Int. Cl. F27D 11/02; H05B 3/14; H05B 3/62

(52) U.S. Cl. CPC F27D 11/02; H05B 3/141; H05B 3/62; H05B 2214/03

(57) ABSTRACT

Systems and methods are described for a multi-layer heating system. The heating system may include an electrically conductive refractory layer; an electrically insulating layer; and a thermally insulating layer between the electrically conductive refractory layer and the electrically insulating layer. The electrically conductive refractory layer may operate at a significantly higher temperature than the electrically insulating layer. The heating system may also include a wall of a furnace, and an air gap between the thermally insulating layer and the wall of the furnace.

### TECHNICAL FIELD

The present disclosure relates to systems and methods for transferring thermal energy and, more particularly, to heating devices for electrically heated processes.

### BACKGROUND

High temperature furnaces are useful for various applications, including, but not limited to chemical processes. In particular, electric radiative high temperature furnaces have been contemplated for steam cracking, steam methane reforming (SMR), reforming for ammonia, dehydrogenation, tar cracking, or similar applications. Such processes and furnaces for heating such processes traditionally use combustion. To meet new sustainability and carbon dioxide emission reduction requirements such fired heaters may need to be replaced.

Recent developments have included heaters and furnaces powered by electricity, preferably renewable electricity. Non-combustion heaters are needed to provide heat to such processes. Exemplary constructions of heaters for such applications have included a conductive heating element, often a metal wire or metal ribbon hung on a non-conductive refractory material, such as a non-conductive refractory brick. In these systems, voltage is applied across the conductive element and the resulting current causes the element to heat up. This is called impedance or ohmic heating. As the elements heat up, they heat the refractory. As the system reaches operating temperature the heater radiates heat from the elements and from the refractory brick out into the furnace box where heat is transferred to furnace tubes. This allows for substitution of combustion with electrically heated systems.

In the above describe systems, however, the allowable operating temperature of the heating elements is limited and lifetime decreases as temperature increases. The operating maximum temperatures may vary, but in general, for metal elements the operating maximum temperatures should not exceed approximately 1300° C.; and even then, their lifetimes are only a few years and require frequent expensive element replacements over the life of the system. In many processes, higher temperatures are required and it is highly desirable that lifetimes be much longer.

For electrically powered processes, Applicant has identified a need for systems and methods for heating using heaters that are able to operate at high temperatures and/or with longer lifetimes.

### SUMMARY

In an embodiment of the present disclosure, a multi-layer heating system may include an electrically conductive refractory layer; an electrically insulating layer; and a thermally insulating layer positioned between the electrically conductive refractory layer and the electrically insulating layer. Certain embodiments may also include a wall of a furnace, and an air gap between the electrically insulating layer and the wall of the furnace.

In certain embodiments, the electrically conductive refractory layer may be capable of operating at a significantly higher temperature than the electrically insulating layer. In some embodiments, the significantly higher temperature may be at least 200° C.; in other embodiments the significantly higher temperature may be at least 500° C. In certain embodiments, the electrically conductive refractory layer may be less than four inches thick; in still other certain embodiments the conductive refractory layer may be less than one inch thick. In certain embodiments, the electrically conductive refractory layer, the electrically insulating layer, and the thermally insulating layer may be held together with one or more ceramic bolts. In certain embodiments, the bolts may be conductive in proximity to the electrically conductive refractory layer, but an effective electrical insulator in proximity to the electrically insulating layer.

In certain embodiments, the electrically conductive refractory layer and the electrically insulating layer are independently a material that is conductive at a higher temperature, but an effective electrical insulator at a lower temperature. In certain embodiments, the multi-layer heating system may be disposed within a furnace, and where the electrically conductive layer may radiate heat to the interior of the furnace.

In certain embodiments, the electrically conductive layer may radiate heat to a process fluid. In certain embodiments, the process fluid may be a hydrocarbon. In certain embodiments, the furnace may be a steam cracking furnace. In certain embodiments, the furnace may be a steam methane reforming furnace. In certain embodiments, the electrically conductive refractory layer may be capable of operating at a temperature greater than 1000° C., preferably greater than 1200° C., and more preferably greater than 1400° C. In certain embodiments, the electrically insulating layer may be capable of operating at a temperature less than 900° C., preferably less than 500° C., and more preferably less than 300° C. In certain embodiments, the electrical conductivity ratio between the electrically conductive refractory layer and the electrically insulating layer, while the multi-layer heating system is operating, may be greater than 3, more preferably greater than 10, in other words the electrical resistivity of the electrically conductive layer is significantly less than the electrical resistivity of the electrically insulating layer when the system is operating at temperatures generally encountered in a furnace during steam cracking (about 800°-900° C.).

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic view of an exemplary conductive refractory system.

FIG. 2 is a flow diagram of conductive refractory systems used as a furnace.

FIG. 3 is a schematic diagram of a multi-layer heating system.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the term “significantly” means of a size and/or effect that is large or important enough to be noticed or have an important effect.

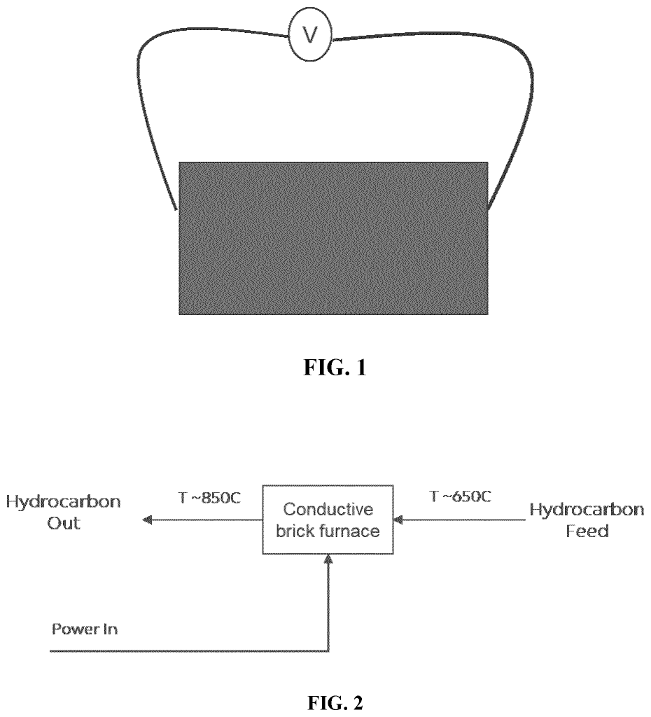

In embodiments of the present invention as shown in FIG. 1, electricity is applied directly to a conductive refractory material and heat is generated by the conductive refractory system. There may be no separate heating elements such as metal wires, or ceramic heating elements.

Electric heating technologies may provide heat to process streams via conductive refractory systems. The heat may be used to raise the temperature of a process stream or to provide the heat of reaction needed to drive a chemical reaction, or both. For purposes of this application, reference may be made to “bricks”, but the system could be provided in various formats, sizes, shapes, such as a cylinder, cone, tile, and other configurations depending on the needs of particular embodiments. The use of conductive refractory materials, such as refractory bricks, may provide an alternative to the metal wire or metal ribbon heating elements, or separate ceramic or other types of heating elements that are not integrated components of the refractory system, such as silicon carbide (SiC) or molybdenum carbide (MoC) heating elements. The use of conductive refractory materials may further eliminate or reduce certain design constraints of those existing systems. In general, the conductive refractory materials may be bricks (having a rectangular or square box-shape) with no metal conducts but instead current flows through the conductive refractory materials. In certain embodiments, the conductive refractory material may be ceramic. In certain embodiments, the conductive refractory materials may also be referred to as electrically heated ceramics (EHCs).

Advantages to these conductive refractory systems may include, but are not limited to, the following:
Better simplicity and lower cost. Conductive refractory systems do not utilize separate conductive wires of various materials (metal, ceramic, etc.), so eliminating those conductive wires, which are one of the most expensive components of the heating technology and require frequent replacement, simplifies the system and reduces cost, especially the frequent replacement costs.
Higher heat flux and higher temperatures. Conductive refractory systems may operate at temperatures as high as approximately 2000° C., whereas metal heating elements are limited to approximately 1300° C.
Longer life. Conductive refractory materials may have longer life compared to metal wires and metal ribbons, which are operating near material temperature limits.
Higher process temperatures. The conductive refractory systems may be used to heat process streams to higher temperatures.
A smaller furnace. The conductive refractory systems may attain higher fluxes and a furnace so equipped can utilize a greater portion of the wall area, and thereby reduce the required total surface area and overall furnace size for a given duty.
Higher Voltage. Conductive refractory systems may operate at voltages as high as 13 kV, whereas metal heating elements can operate at much lower voltages of around 690V. In certain embodiments, the electricity may be provided at a voltage greater than 1000 volts, preferably greater than 4000 volts, and most preferably greater than 10000 volts.
Cheaper electrical kit. When operated at higher voltages, the furnace requires much lower amperage, and thus the required electrical equipment may be significantly less expensive. Electrical equipment may include, but is not limited to, step down transformers, control elements, switch gear, conductors, connections, and other devices.

Deploying these conductive refractory materials in a furnace is not so simple. The interior temperatures of the conductive refractory materials can be much higher (hotter) than the radiating surface and must be kept below the refractory material limit of around 2000° C. Moreover, the conductive refractory materials are at very high potential—possibly more than 10 kV—and they must be deployed in a way that prevents stray current or short circuits which are both an operability and a safety problem. To complicate matters even further, it is extremely difficult to find materials that can act as an effective electrical insulator at these high temperatures.

Certain embodiments of the present invention relate to a multi-layer heating wall that can be deployed inside a furnace box to manage these challenges.

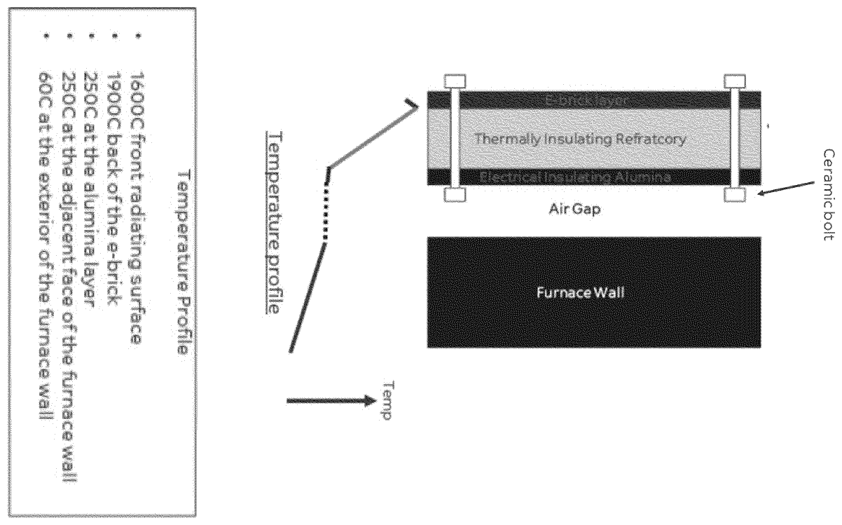

FIG. 2 is a flow diagram of conductive refractory systems used as a furnace. In certain embodiments, a hydrocarbon feed may be fed into a furnace at, for example, but not limited to, a temperature of approximately 650° C. Electrical energy is supplied to a multi-layered heating system within the furnace. Hydrocarbons may exit the furnace at, for example, but not limited to, temperature of approximately 850° C.

FIG. 3 is a schematic diagram of a multi-layered heating system utilizing conductive refractory for a furnace application. One or more multi-layered heating systems may be disposed within a furnace. A multi-layered heating system may be referred to herein as a “wall”. In certain embodiments, the multi-layered heating system may be self-supporting. In certain embodiments, wall may be constructed as follows:
1) A first layer may be a layer of conductive refractory materials. This is a layer in which heat is generated by ohmic heating and whose surface may radiate heat out into the furnace. The radiating (or outer) surface of the conductive refractory materials may operate at approximately 100° C. or higher. Because heat is being ohmically generated throughout the volume of the conductive refractory layer, the temperature at the back (or inner) surface may be even higher (hotter) and may approach the material limit of approximately 2000° C.
2) A second layer may be a layer of a thermal insulting refractory. The temperature at the interface between the conductive refractory materials and the thermal insulating refractory may be the highest (hottest place) on the wall. The temperature may drop rapidly through the insulating refractory moving away from the conductive refractory materials.
3) A third layer may be an electrically insulating layer. In certain embodiments, the electrically insulating layer may be a high purity alumina, but other materials are possible. Because the electrically insulating layer may be attached at the back of the thermally insulating layer, it may operate at a much lower temperature than the conductive refractory materials. Through the arrangement of layers described herein, the system may allow the conductive refractory to operate at very high temperatures while having the electrically insulating layer operate at a significantly lower temperature.
4) A fourth layer may be an air gap. This air gap may provide an additional layer of protection and security for the system by preventing any stray currents or short circuits between the wall and other components of the furnace.
5) A fifth layer may be a wall of a furnace. This may be an outer wall of the furnace. The materials of construction are not critical, but it preferably contains a layer of effective thermal insulation to minimize heat losses from the furnace.

Optionally, it might be possible to clamp the layers of the wall together using ceramic bolts. The bolts would be conductive in the hot region of the conductive refractory materials, but electrically insulating the cold region of the electrically insulating layer.

The systems and methods described herein may be used to heat a process stream or to provide the heat of reaction for endothermic chemistry with or without a catalyst. For example, when used in a furnace like FIG. 2, a pressurized gas may be fed to the system via an inlet and directed to or near the multi-layered wall, in particular, the electrically conductive layer. The heating of the electrically conductive layer will supply heat to the process stream and the hot product gas can then be led to an outlet of the system.

According to another embodiment, there is provided a conductive refractory system including a) a multi-layered heating wall comprising (i) an electrically conductive refractory layer, (ii) an electrically insulating layer, and (iii) a thermally insulating layer positioned between the electrically conductive refractory layer and the electrically insulating layer where the electrical resistivity of the electrically conductive refractory layer is significantly less than the electrical resistivity of the electrically insulating layer; and b) at least two connections electrically connected to the multi-layered wall and to an electrical power supply where the electrical power supply is dimensioned to be capable of heating at least part of the multi-layered wall to a temperature of at least 1000° C. by passing an electric current through the electrically conductive layer.

In one embodiment, at least part of an inner surface of the electrically conductive refractory layer is in contact with at least part of an outer surface of the thermally insulating layer. In another embodiment, an inner surface of the thermally insulating layer is in contact with at least part of an outer surface of the electrically insulating layer.

According to one embodiment, the electrically conductive layer comprises metal oxide particles, metal nitride particles, metal carbide particles, metal sulfide particles, metal silicide particles, metal boride particles, particles of multiferroic compounds, mixed ceramic particles, chalcogenide glass particles, or a combination thereof. In other embodiments, the electrically conductive layer has an electrical resistivity of between about 10⁻⁵ Ohm·m to about 10⁻⁸ Ohm·m at 20° C.

Examples of metal oxide particles include, but are not limited to, doped and undoped particles of tin oxide, iron oxide (ferrous or ferric oxide), zinc oxide, manganese oxide, lead oxide, nickel oxide, cobalt oxide, silver oxide, antimony oxide, and copper oxide (CuO), chromium oxide. Mixtures of metal oxide particles are also suitable.

Examples of metal nitride particles include, but are not limited to, doped and undoped particles of tantalum nitride, titanium nitride, vanadium nitride, and zirconium nitride. Mixtures of metal nitride particles are also suitable.

Examples of metal carbide particles include doped and undoped particles of tungsten carbide, niobium carbide, titanium carbide, vanadium carbide, molybdenum carbide, silicon carbide, zirconium carbide, boron carbide, and titanium silicon carbide. Mixtures of metal carbide particles are also suitable.

Examples of metal sulfide particles that are suitable include doped and undoped particles of copper sulfide, silver sulfide, iron sulfide, nickel sulfide, cobalt sulfide, lead sulfide, and zinc sulfide. Mixtures of metal sulfide particles are also suitable.

Examples of metal silicide particles that are suitable include doped and undoped particles of chromium silicide, molybdenum silicide, cobalt silicide, vanadium silicide, tungsten silicide, and titanium silicide. Mixtures of metal silicide particles are also suitable.

Examples of metal boride particles that are suitable include doped and undoped particles of chromium boride, molybdenum boride, titanium boride, zirconium boride, niobium boride, and tantalum boride. Mixtures of metal boride particles are also suitable.

Examples of particles of multiferroic compounds include, but are not limited to, doped and undoped particles of bismuth ferrite (BiFeO₃), bismuth manganate (BiMnO₃), and rare earth-iron oxides (MFe₂O₄ where M is a rare earth element, such as, for example, LuFe₂O₄). Mixtures of particles of multiferroic compounds are also suitable.

Examples of mixed ceramic particles include particles with a mixture of metal or metalloid elements. Suitable examples include, but are not limited to, doped and undoped particles of silicon carbide and beryllium oxide, silicon carbide and aluminum nitride, copper oxide (CuO) and aluminum oxide, aluminum nitride and glassy carbon, and Si—Ti—C—N ceramics. Examples of chalcogenide glass particles include glassy materials based on As—Ge—Te and Se—Ge—Te.

In one embodiment, the electrically conductive layer has a thickness of less than about 6 inches, or preferably less than about 3 inches, or less than 2 inches, or most preferably less than 1 inch. In another embodiment, the electrically conductive layer has a thickness from about 1 inch to 6 inches, or from about 1.5 inches to about 3 inches.

In another embodiment, the electrically insulating layer comprises alumina, magnesium oxide, silicon oxide, silicon nitride, silicon oxynitride, silicon carbide or combinations thereof. In one embodiment, the electrically insulating layer has an electrical resistivity of greater than 10 Ohm·m at 20° C., such as between about 10⁹ Ohm·m to about 10²⁵ Ohm·m at 20° C. In some embodiments, the insulating layer is capable of having a cold side (inner surface) temperature of less than 400° C., preferably less than 250° C., most preferably less than 150° C. when the system is operating at temperatures generally encountered in a furnace during steam cracking (about 800°-900° C.).

According to another embodiment, the thermally insulating layer comprises zirconium, zirconium alloy, titanium nitride, titanium carbide, titanium nitride alloy, titanium carbide alloy, alkali titanate, silicon resin, silica fiber, fiberglass, a ceramic fiber or combinations thereof. In some embodiments, the temperature drop across the thermally insulating layer is greater than 200° C., preferably greater than 500° C., most preferably greater than 1000° C. when the system is operating at temperatures generally encountered in a furnace during steam cracking (about 800°-900° C.).

When the conductive refractory system comprises an air gap between the multi-layered wall and the wall of the furnace, additional heat and electrical insulation between the multi-layered wall and the wall of the furnace can be obtained. The presence of the air gap assists in avoiding excessive thermal losses to the surroundings and also to protect against stray current reaching the outer wall of the furnace. The temperatures of the multi-layered wall may reach up to about 2000° C., in at least at some parts thereof when the system is operating at temperatures generally encountered in a furnace during steam cracking (about 800°-900° C.), but by using the air gap between the multi-layered wall and the wall of the furnace, the temperature of the wall of the furnace can be kept at significantly lower temperatures of, for example, less than about 300° C. or even less than about 100° C.

It should be noted, that the conductive refractory system of the present invention may include any appropriate number of power supplies and any appropriate number of connections connecting the power supply/supplies and the electrically conductive layer of the multi-layered wall.

While the foregoing is directed to embodiments of the present disclosure, other and further embodiments of the disclosure may be devised without departing from the basic scope thereof, and the scope thereof is determined by the claims that

1. A multi-layer heating system comprising:
an electrically conductive refractory layer;
an electrically insulating layer; and
a thermally insulating layer between the electrically conductive refractory layer and the electrically insulating layer,
wherein the electrical resistivity of the electrically conductive refractory is significantly less than the electrical resistivity of the electrically insulating layer.

2. The multi-layer heating system according to claim 1, further comprising a wall of a furnace, and an air gap positioned between the electrically insulating layer and the wall of the furnace.

3. The multi-layer heating system according to claim 1, wherein during operation, the temperature of the electrically conductive layer is significantly higher than the temperature of the electrically insulating layer by at least 100° C.

4. The multi-layer heating system according to claim 1, wherein the electrically conductive refractory layer is less than two inches thick.

5. The multi-layer heating system according to claim 1, wherein the electrically conductive refractory layer, the electrically insulating layer, and the thermally insulating layer are held together with one or more ceramic bolts.

6. The multi-layer heating system according to claim 5, wherein the bolts are conductive in proximity to the electrically conductive refractory layer, but an effective electrical insulator in proximity to the electrically insulating layer.

7. The multi-layer heating system according to claim 1, wherein the electrically conductive refractory layer and the electrically insulating layer each comprise a different material that is conductive at a higher temperature, but an effective electrical insulator at a lower temperature.

8. The multi-layer heating system according to claim 1, wherein the multi-layer heating system is disposed within a furnace, and wherein the electrically conductive layer radiates heat to the interior of the furnace.

9. The multi-layer heating system according to claim 1, wherein during operation the electrically conductive layer radiates heat to a process fluid.

10. The multi-layer heating system according to claim 9, wherein the process fluid is a hydrocarbon.

11. The multi-layer heating system according to claim 8, wherein the furnace is a steam cracking furnace.

12. The multi-layer heating system according to claim 11, wherein the furnace is a steam methane reforming furnace.

13. The multi-layer heating system according to claim 1, wherein during operation a radiating surface of the electrically conductive refractory layer has a temperature greater than 1000° C.

14. The multi-layer heating system according to claim 1, wherein during operation the electrically insulating layer has a temperature less than 900° C.

15. The multi-layer heating system according to claim 1, wherein the electrically conductive layer has an electrical resistivity of between about 10⁻⁵ Ohm·m to about 10⁻⁸ Ohm·m at 20° C.

16. The multi-layer heating system according to claim 1, wherein the electrically insulating layer has an electrical resistivity of greater than 10 Ohm·m at 20° C.
